(19) United States
(12) Patent Application Publication
(10) Pub. No.: US 2025/0278141 A1
(43) Pub. Date: Sep. 4, 2025

(54) PEN

(71) Applicant: Wacom Co., Ltd., Saitama (JP)

(72) Inventors: Shunya SAITO, Saitama (JP); Noboru YAMAGUCHI, Saitama (JP)

(21) Appl. No.: 19/209,524

(22) Filed: May 15, 2025

Related U.S. Application Data
(63) Continuation of application No. PCT/JP2023/044843, filed on Dec. 14, 2023.

(30) Foreign Application Priority Data
Dec. 20, 2022 (JP) 2022-203167

(51) Int. Cl. G06F 3/01; G06F 3/0354; G06F 3/038

(52) U.S. Cl. CPC G06F 3/016; G06F 3/03545; G06F 3/0383

(57) ABSTRACT

A pen includes a vibration device including a vibrator, and a processing unit that suppresses movement of the vibrator during a pen non-use period during which no pen input is being performed.

### BACKGROUND

### Technical Field

The present disclosure relates to a pen, and particularly to a pen having a haptic function.

### Description of the Related Art

Some pens used to perform pen input on a panel surface have a function that reproduces a tactile sensation felt when using a traditional pen such as a ballpoint pen or a pencil (hereinafter referred to as a “haptic function”). This type of pen typically has a built-in vibration device, and is configured to vibrate the vibration device depending on whether the pen tip is in contact with the panel surface, whether the pen tip is traveling on the panel surface, etc. Japanese Patent Laid-open No. 2014-222492 discloses an example of a pen having such configuration.

When the tip of a pen having a built-in vibration device is brought into contact with a panel surface, there are cases where the vibration device may vibrate due to the impact of the contact, even though there is no electrical control to make the device vibrate. This is because the vibrator inside the vibration device moves due to the physical impact. Such vibration gives an uncomfortable feeling to the user and should be suppressed.

### BRIEF SUMMARY

According to one aspect, a pen is provided that can suppress vibration of a vibration device caused by an impact when the pen tip is brought into contact with a panel surface.

The present disclosure relates to a pen including a vibration device containing a vibrator, and a processing unit that suppresses movement of the vibrator during a pen non-use period during which no pen input is being performed.

According to the present disclosure, the movement of the vibrator is suppressed during the pen non-use period, so as to suppress vibration of the vibration device caused by the impact generated when the pen tip is brought into contact with the panel surface.

### BRIEF DESCRIPTION OF THE SEVERAL VIEWS OF THE DRAWINGS

FIG. 1 is a diagram illustrating the system configuration of a position detecting system according to a first embodiment of the present disclosure;

FIGS. 2A and 2B are diagrams illustrating the structure of a vibration device;

FIG. 3 is a diagram illustrating functional blocks of a pen and an electronic device;

FIG. 4 is a process flow diagram illustrating the control of the vibration device executed by a short-range wireless communication unit according to the first embodiment of the present disclosure;

FIG. 5 is a diagram illustrating the functional blocks of the pen and the electronic device according to a second embodiment of the present disclosure;

FIG. 6 is a process flow diagram illustrating the control of the vibration device executed by a short-range wireless communication unit according to the second embodiment of the present disclosure;

FIG. 7 is a diagram illustrating functional blocks of the pen according to a third embodiment of the present disclosure;

FIG. 8 is a process flow diagram illustrating the control of the vibration device executed by a short-range wireless communication unit according to the third embodiment of the present disclosure;

FIG. 9 is a process flow diagram illustrating the control of the vibration device executed by a short-range wireless communication unit according to a fourth embodiment of the present disclosure; and

FIG. 10 is a process flow diagram illustrating the control of the vibration device executed by a short-range wireless communication unit according to the background art of the present disclosure.

### DETAILED DESCRIPTION

Embodiments of the present disclosure will be described in detail with reference to the accompanying drawings.

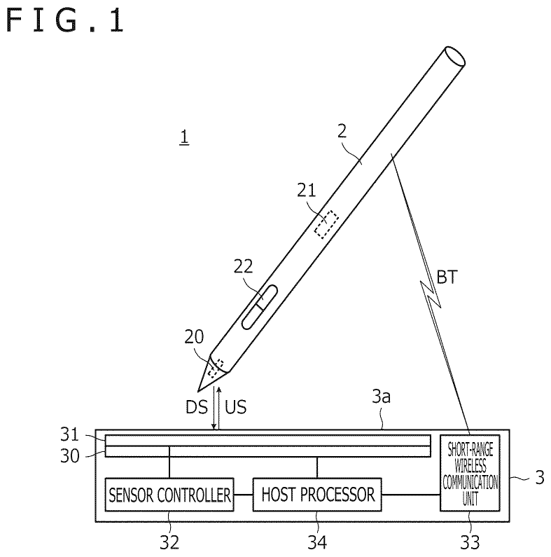

FIG. 1 is a diagram illustrating the system configuration of a position detecting system 1 according to a first embodiment of the present disclosure. As illustrated in the figure, the position detecting system 1 includes a pen 2 and an electronic device 3.

The pen 2 is an active pen compatible with an active capacitance method, and includes a pen tip electrode 20, a vibration device 21, and a side switch 22. In the present embodiment, the description will continue assuming that the pen 2 is an active pen, but other types of pens can also be used as the pen 2, such as an electromagnetic induction pen compatible with an electromagnetic induction method (EMR method).

The pen tip electrode 20 is a conductor disposed near the pen tip of the pen 2. The pen 2, which is an active pen, is configured to use this pen tip electrode 20 to perform bidirectional communication with a sensor controller 32 provided in the electronic device 3. Hereinafter, a signal transmitted from the sensor controller 32 to the pen 2 through this communication will be referred to as an “uplink signal US,” and a signal transmitted from the pen 2 to the sensor controller 32 through this communication will be referred to as a “downlink signal DS.”

The uplink signal US is a signal modulated by data to be transmitted from the sensor controller 32 to the pen 2. The data includes data indicating the traveling speed of the pen 2 on the panel surface as well as commands that define the operation of the pen 2. The downlink signal DS includes an unmodulated burst signal and a data signal modulated by data to be transmitted from the pen 2 to the sensor controller 32. The burst signal is used by the sensor controller 32 to detect the position of the pen 2. The data transmitted as the data signal includes data concerning a writing pressure value indicating the pressure applied to the pen tip, on/off information of the side switch 22, a pen identification (ID) previously assigned to the pen 2, etc.

The vibration device 21 is a device including a vibrator that vibrates in response to an electric signal, and is typically a linear resonant actuator (LRA). However, the present disclosure is also applicable to the pen 2 having a vibration device other than a linear resonant actuator (LRA).

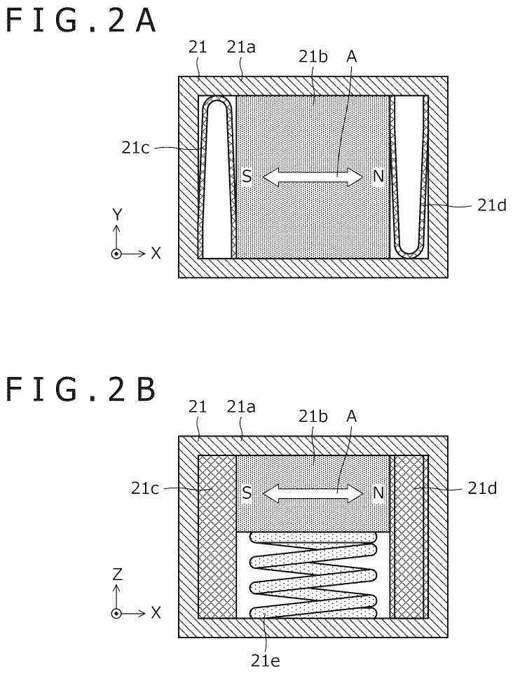

FIGS. 2A and 2B are diagrams illustrating an example of the structure of the vibration device 21. FIG. 2A is a cross-sectional view of the vibration device 21 taken along the XY plane, and FIG. 2B is a cross-sectional view of the vibration device 21 taken along the XZ plane. As illustrated in FIGS. 2A and 2B, the vibration device 21, which is a linear resonant actuator, has a configuration in which a rectangular parallelepiped-shaped vibrator 21b, leaf springs 21c and 21d, and a coil 21e are arranged in a rectangular parallelepiped-shaped housing 21a.

The vibrator 21b is a permanent magnet having an S pole at one end in an X direction and an N pole at the other end, and is so arranged as to be able to move in the illustrated A direction (parallel to the X direction). The leaf spring 21c is arranged between a surface on one side of the vibrator 21b in the X direction and the inner surface of the housing 21a facing the surface on one side. Further, the leaf spring 21d is arranged between the surface on the other side of the vibrator 21b in the X direction and the inner surface of the housing 21a facing the surface on the other side. With this arrangement, the leaf springs 21c and 21d each play a role of biasing the vibrator 21b toward the inside of the housing 21a.

The coil 21e is a member that generates an alternating magnetic field in response to an electric signal (alternating current) supplied from the outside, and is disposed below the vibrator 21b in a Z direction. In the coil 21e, the magnetic field lines generated at the center of the coil 21e when a current is passed through the coil 21e would have a direction in parallel to the Z direction. When an alternating magnetic field is generated in the coil 21e, force corresponding to the direction of the magnetic field being generated is applied to the vibrator 21b. Due to the force thus applied and the biasing force of the leaf springs 21c and 21d, the vibrator 21b vibrates in the illustrated direction A when an electric signal is supplied to the coil 21e from the outside. The haptic function of the pen 2 is achieved by the vibration of the vibrator 21b.

Referring back to FIG. 1, the electronic device 3 is a computer that supports pen input to a panel surface 3a, and includes a display device 30, a sensor 31, the sensor controller 32, a short-range wireless communication unit 33, and a host processor 34. In a typical example, the electronic device 3 is a smartphone or a tablet terminal.

The display device 30 is a device that displays an image on the panel surface 3a in accordance with a video signal supplied from the host processor 34, and is configured of, for example, a liquid crystal display or an organic electroluminescence (EL) display.

The sensor 31 is a device having a plurality of linear electrodes each extending inside the panel surface 3a. Each linear electrode is made of a transparent conductor and is disposed on the display surface of the display device 30. This allows pen input to be carried out on the display surface of the electronic device 3. However, the electronic device 3 may be an electronic device (such as a digitizer) that performs pen input on a surface that is not a display surface.

The sensor controller 32 is an integrated circuit having functions of detecting a position of the pen 2 on the panel surface 3a, receiving data transmitted by the pen 2, and supplying the detected position data and received data to the host processor 34. Specifically, the sensor controller 32 periodically transmits uplink signal US by generating the uplink signal US including a command for the pen 2 and supplying the uplink signal US to some or all of the plurality of linear electrodes. The sensor controller 32 receives downlink signal DS transmitted from the pen 2 in response to the uplink signal US each time the uplink signal US is transmitted. Specifically, the sensor controller 32 receives the burst signal constituting the downlink signal DS at each of the plurality of linear electrodes, and detects the position of the pen 2 according to the reception intensity at each linear electrode. The sensor controller 32 acquires the data transmitted from the pen 2 by demodulating the downlink signal DS received at any one of the linear electrodes.

The sensor controller 32 also performs a process of deriving the traveling speed of the pen 2 on the panel surface 3a in reference to the history of the detected positions of the pen 2. The sensor controller 32 is configured to include data indicating the derived traveling speed in the uplink signal US together with the command.

The short-range wireless communication unit 33 is, for example, a communication device that performs bidirectional communication with other devices by short-range wireless communication BT such as the Bluetooth (registered trademark) communication standard. As will be described in detail later, the pen 2 is compatible with the short-range wireless communication BT also, and the short-range wireless communication unit 33 performs communication with the pen 2 by the short-range wireless communication BT under the control of the host processor 34.

The host processor 34 is a central processing unit of the electronic device 3 that plays a role of executing a program read from an unillustrated memory and executing the operating system and various applications of the electronic device 3. The host processor 34 also has a role of supplying a video signal obtained as a result of the execution of the program to the display device 30.

The applications executed by the host processor 34 include a drawing application that performs drawing according to the traveling trajectory of the pen 2. The drawing application plays a role of executing a process of generating stroke data (data indicating a trajectory of positions) by using the position information and data supplied from the sensor controller 32, a process of rendering the generated stroke data and displaying the data on the display device 30, a process of generating and recording digital ink including the generated stroke data, and a process of transmitting the generated digital ink to an external device.

The drawing application is configured to be able to set information required for rendering the generated stroke data, through user operation (hereinafter referred to as “rendering information”). Specific examples of the rendering information include information regarding the type and size of the brush (pen tip), the width of the line that is input, etc. The rendering information that has been set is used by the drawing application for rendering the stroke data, and is also used to vibrate the vibration device 21 in the pen 2.

The latter point will be described in detail. The drawing application stores in advance a table that associates rendering information with identification information. The identification information identifies the waveform pattern of an electric signal (alternating current) supplied to the vibration device 21. When the drawing application is started or when the rendering information is changed, the drawing application performs a process of reading from this table the identification information corresponding to the currently set rendering information. The drawing application generates a control signal indicative of the read-out identification information, and uses the short-range wireless communication unit 33 to transmit the control signal via the short-range wireless communication BT to the pen 2. While details of the process executed by the pen 2 that has received the control signal transmitted in this manner will be described later, this results in, while the user is writing with the pen 2, the vibration device 21 vibrating according to the waveform pattern indicated by the transmitted identification information.

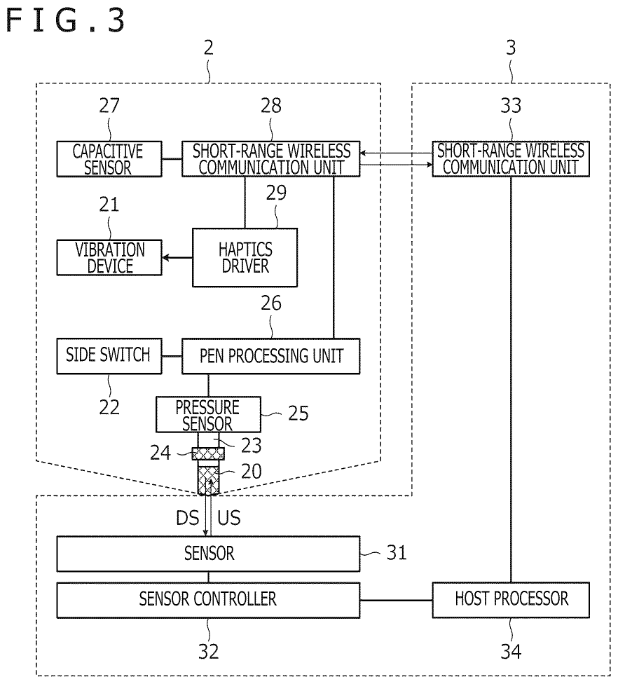

FIG. 3 is a diagram illustrating functional blocks of the pen 2 and the electronic device 3. The functional blocks of the electronic device 3 illustrated in this figure are the same as those illustrated in FIG. 1. However, the display device 30 is omitted.

As illustrated in FIG. 3, the pen 2 includes a core body 23, a ring electrode 24, a pressure sensor 25, a pen processing unit 26, a capacitive sensor 27, a short-range wireless communication unit 28, and a haptics driver 29 as well as the pen tip electrode 20, the vibration device 21, and the side switch 22 that are also illustrated in FIG. 1.

The core body 23 is a substantially cylindrical member that constitutes the pen tip of the pen 2. The pen tip electrode 20 is formed at the tip of the core body 23. The ring electrode 24 is a ring-shaped conductor disposed in the middle of the core body 23. The function of the ring electrode 24 will be described later.

The tip of the core body 23 protrudes from the tip of the pen 2, and the rear end of the core body 23 is in contact with the pressure sensor 25. The pressure sensor 25 is a sensor that detects the pressure applied to the tip (pen tip) of the core body 23 through this contact, and is configured to supply a writing pressure value indicating the detected pressure to the pen processing unit 26.

The side switch 22 is an assembly of one or more switches each of which can be turned on and off by the user. On/off information regarding each switch is supplied to the pen processing unit 26.

The pen processing unit 26 is an integrated circuit that performs processing of receiving the uplink signal US via the pen tip electrode 20 or the ring electrode 24, and also generating the downlink signal DS according to the received uplink signal US and transmitting the signal via the pen tip electrode 20. The pen processing unit 26 is configured to generate the downlink signal DS to be transmitted, in accordance with a command indicated by the received uplink signal US. The downlink signal DS thus generated includes an unmodulated burst signal, and data signals including a writing pressure value supplied from the pressure sensor 25 to the pen processing unit 26 and on/off information regarding each switch supplied from the side switch 22 to the pen processing unit 26.

There are also cases where the pen processing unit 26 may transmit the downlink signal DS from the ring electrode 24. This downlink signal DS may be a simple burst signal, or may be a signal including a burst signal and a data signal, similarly to the downlink signal DS transmitted from the pen tip electrode 20. The burst signal transmitted from the ring electrode 24 is used by the sensor controller 32 to detect the inclination of the pen 2.

The pen processing unit 26 performs processing to supply data indicating the writing pressure value supplied from the pressure sensor 25 and the traveling speed of the pen 2 contained in the received uplink signal US to the short-range wireless communication unit 28. The processing performed by the short-range wireless communication unit 28 upon receiving this supply will be described later.

The capacitive sensor 27 is a capacitance type sensor disposed on the surface (side surface) of the pen 2, and serves to detect the user's finger. The capacitive sensor 27 performs processing to detect the user's finger according to control of the short-range wireless communication unit 28. The detection result is supplied from the capacitive sensor 27 to the short-range wireless communication unit 28.

The short-range wireless communication unit 28 is a communication device that performs bidirectional communication with other devices via the short-range wireless communication BT, and is also a control device for the vibration device 21. The short-range wireless communication unit 28 receives the above-mentioned control signal from the electronic device 3 via the short-range wireless communication BT, and plays a role of controlling the haptics driver 29 in response to the received control signal. The haptics driver 29 is a circuit that generates an electrical signal (alternating current) in response to the control signal and supplies the generated electrical signal to the coil 21e of the vibration device 21.

The control of the haptics driver 29 by the short-range wireless communication unit 28 will be described in more detail. The short-range wireless communication unit 28 stores in advance a table that associates identification information which identifies the waveform pattern of an electric signal (alternating current) supplied to the vibration device 21 with the waveform pattern itself. The short-range wireless communication unit 28 performs a process of reading from the above-mentioned table a waveform pattern that corresponds to the identification information indicated by the control signal received from the electronic device 3, to thereby determine the waveform pattern to be supplied to the haptics driver 29.

The short-range wireless communication unit 28 performs a process of determining whether or not to vibrate the vibration device 21 in reference to the data indicating the writing pressure value and the traveling speed of the pen 2 supplied from the pen processing unit 26. As a result of this determination, the short-range wireless communication unit 28 that has determined to vibrate the vibration device 21 performs a process of supplying a waveform pattern determined based on a control signal received from the electronic device 3 to the haptics driver 29.

The haptics driver 29 generates an electric signal (first electric signal) that oscillates according to the waveform pattern supplied from the short-range wireless communication unit 28, and supplies the electric signal to the coil 21e of the vibration device 21. This causes the vibration device 21 to vibrate with the waveform pattern designated by the electronic device 3.

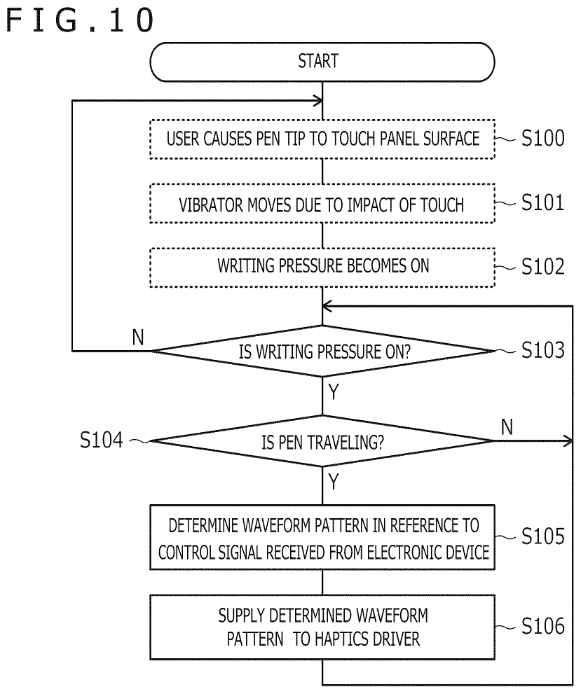

FIG. 10 is a process flow diagram illustrating the control of the vibration device 21 executed by the short-range wireless communication unit 28 according to the background art of the present disclosure. With reference to FIG. 10, a problem of the control of the vibration device 21 executed by the short-range wireless communication unit 28 to which the present disclosure is not applied will be described in more detail.

Steps S100 to S102 indicated by broken lines are operations or processes performed outside the short-range wireless communication unit 28. First, the user causes the pen tip of the pen 2 to touch the panel surface 3a (step S100). As a result, the vibrator 21b in the vibration device 21 moves due to the impact of the touch (step S101). One aspect of the present disclosure is to suppress the vibration of the vibration device 21 caused by this movement. When the pen tip comes into contact with the panel surface 3a, the writing pressure value supplied from the pressure sensor 25 to the pen processing unit 26 becomes a value indicating a contact (e.g., a value greater than 0) (step S102). When the writing pressure value is a value indicating a contact, it is considered that “a writing pressure is on,” and when the writing pressure value is a value not indicating a contact (e.g., 0), it is considered that “a writing pressure is off.”

Steps S103 and S104 are processes for determining whether or not the user is writing with the pen 2. Specifically, the short-range wireless communication unit 28 first determines whether or not the writing pressure is on by referring to the writing pressure value sequentially supplied from the pen processing unit 26 (step S103). If it is determined that the writing pressure is not on, the short-range wireless communication unit 28 determines that the user is not writing with the pen 2, and returns to step S100 to continue the processing. On the other hand, the short-range wireless communication unit 28 that has determined that the writing pressure is on determines whether or not the pen 2 is traveling by referring to data indicating the traveling speed of the pen 2 sequentially supplied from the pen processing unit 26 (step S104). If it is determined that the pen 2 is not moving (traveling), the short-range wireless communication unit 28 determines that the user is not writing with the pen 2, and returns to step S103 to continue the processing.

On the other hand, in the case of determining in step S104 that the pen 2 is traveling, the short-range wireless communication unit 28 determines that the user is writing with the pen 2. Then, the short-range wireless communication unit 28 determines a waveform pattern in reference to the control signal received from the electronic device 3 (step S105), and supplies the determined waveform pattern to the haptics driver 29 (step S106). As a result, since an electric signal that oscillates according to the determined waveform pattern is supplied from the haptics driver 29 to the vibration device 21, the vibration device 21 of the pen 2 is vibrated with a pattern according to the rendering information currently set in the drawing application while the user is writing with the pen 2. Such control of the vibration device 21 cannot suppress the movement of the vibrator 21b in step S101.

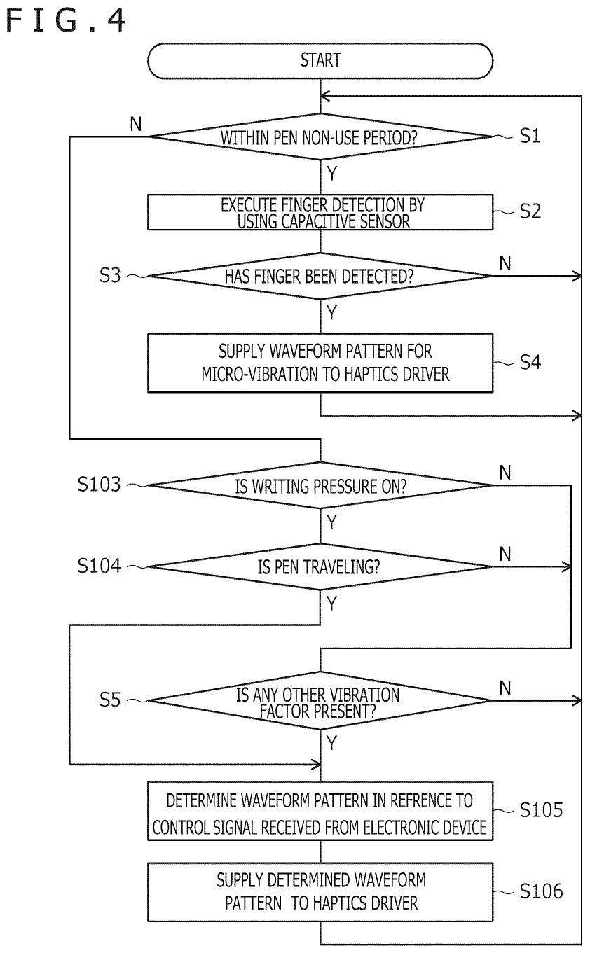

Now referring back to FIG. 3, in order to suppress the movement of the vibrator 21b in step S101 of FIG. 10, in addition to controlling the vibration device 21 illustrated in FIG. 10, the short-range wireless communication unit 28 according to the present disclosure performs control to suppress the movement of the vibrator 21b during the pen non-use period during which no pen input is performed. Specifically, the short-range wireless communication unit 28 supplies an electric signal for vibrating the vibrator 21b with an amplitude so small that the user cannot perceive the vibration (a second electric signal that oscillates with an amplitude smaller than that of the first electric signal described above) to the vibration device 21 during the pen non-use period, to thereby suppress the movement of the vibrator 21b during the pen non-use period. This prevents the vibrator 21b from moving freely, making it possible to suppress the vibration of the vibration device 21 caused by the impact generated when the pen tip is brought into contact with the panel surface 3a. FIG. 4 is a process flow diagram illustrating the control of the vibration device 21 executed by the short-range wireless communication unit 28 according to the present embodiment. As illustrated in FIG. 4, the short-range wireless communication unit 28 first determines whether or not the current time is within a pen non-use period (step S1). Specifically, the short-range wireless communication unit 28 may make the determination of step S1 by considering a period during which the writing pressure is off as the pen non-use period, or by considering a period during which the writing pressure is off and the pen 2 is not traveling as the pen non-use period. Alternatively, the short-range wireless communication unit 28 may enter the pen non-use period based on an explicit operation performed by the user using the side switch 22, and make the determination of step S1 depending on whether or not the pen non-use period has been entered.

The short-range wireless communication unit 28 that has determined in step S1 that the current time is not within the pen non-use period executes the processes of steps S103 to S106 described with reference to FIG. 10. As a result, while the user is writing with the pen 2, the vibration device 21 of the pen 2 vibrates in patterns according to the rendering information currently set in the drawing application, as described above.

The short-range wireless communication unit 28 according to the present embodiment is configured to further determine, when a negative determination result is obtained in step S103 or step S104, whether there is any other basis (factor) for vibration (step S5). If there is another vibration factor, the process moves to step S105. This process enables generation of vibrations other than those intended to reproduce the tactile sensation during a writing operation. Those other vibrations include, for example, vibrations as a warning alert regarding a remaining battery level or vibrations in response to an instruction received at an arbitrary timing from the electronic device 3. The instruction received from the electronic device 3 may be transmitted via the short-range wireless communication BT or may be transmitted in the uplink signal US. The instruction may include identification information which identifies the waveform pattern of the electrical signal to be supplied to the vibration device 21, and in this case, the waveform pattern determined in step S105 may preferably be the waveform pattern indicated by the identification information.

When a negative determination result is obtained in step S5, or when the process of step S106 (supplying the determined waveform pattern to the haptics driver 29) is completed, the short-range wireless communication unit 28 returns to step S1 to continue the processing. Note that, when some or all of the processes of steps S103 and S104 overlap with the process of step S1, the execution of the overlapping parts of steps S103 and S104 may be omitted.

On the other hand, the short-range wireless communication unit 28 that has determined in step S1 that the current time is within the pen non-use period performs finger detection by using the capacitive sensor 27 (step S2), and determines whether a finger has been detected as a result (step S3). In the case where it is determined that a finger has not been detected, the short-range wireless communication unit 28 returns to step S1 and continues the processing. On the other hand, when it is determined that a finger has been detected, the short-range wireless communication unit 28 supplies a waveform pattern for micro-vibration to the haptics driver 29 (step S4). This waveform pattern is also one of a plurality of waveform patterns stored in advance in the short-range wireless communication unit 28, but unlike the waveform pattern for fulfilling the haptic function, this is a waveform pattern that oscillates with an amplitude so small that the user cannot sense or recognize the vibration. As a result, an electric signal for vibrating the vibrator 21b with an amplitude so small that the user cannot sense the vibration is supplied from the haptics driver 29 to the vibration device 21 (to both ends of the coil 21e), and consequently, the vibrator 21b cannot move freely, so that the vibration of the vibration device 21 caused by the impact generated when the pen tip is brought into contact with the panel surface 3a is suppressed. The short-range wireless communication unit 28 that has completed the supply of the waveform pattern in step S4 returns to step S1 to continue the processing.

As described above, according to the position detecting system 1 of the present embodiment, when the current time is within the pen non-use period and a finger is being detected by the capacitive sensor 27, an electric signal corresponding to a waveform pattern for micro-vibration is supplied to the vibration device 21, so that the movement of the vibrator 21b during the pen non-use period is suppressed. Hence, the vibration of the vibration device 21 caused by the impact generated when the pen tip is brought into contact with the panel surface 3a can be suppressed.

It is to be noted that, in the position detecting system 1 according to the present embodiment, the capacitive sensor 27 does not have to be provided in the pen 2, and steps S2 and S3 in FIG. 4 may be omitted, and the position detecting system 1 still achieves the same effects as described above. However, in this case, the vibration device 21 needs to continue vibrating even when the user leaves the pen 2 on a desk, etc., and thus the power consumption of the pen 2 increases. It is therefore preferable to provide the pen 2 with the capacitive sensor 27 and execute steps S2 and S3 in FIG. 4 as in the present embodiment.

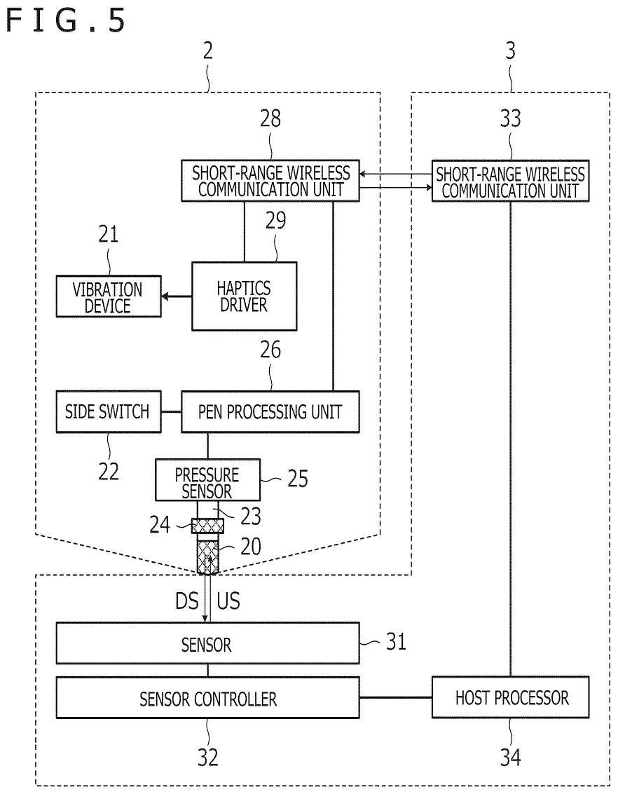

Next, the position detecting system 1 according to a second embodiment of the present disclosure will be described. The position detecting system 1 according to the present embodiment differs from the position detecting system 1 according to the first embodiment in that the pen 2 does not have the capacitive sensor 27 and the short-range wireless communication unit 28 has a sleep mode. The content of the control of the vibration device 21 executed by the short-range wireless communication unit 28 is also different. Otherwise, the position detecting system 1 according to the second embodiment is similar to the position detecting system 1 according to the first embodiment. Below, the position detecting system 1 according to the present embodiment will be described, by focusing on the differences from the position detecting system 1 according to the first embodiment. FIG. 5 is a diagram illustrating functional blocks of the pen 2 and the electronic device 3 according to the present embodiment. As can be understood by comparing FIG. 5 with FIG. 3, the pen 2 according to the present embodiment is not provided with the capacitive sensor 27.

The short-range wireless communication unit 28 according to the present embodiment is configured to operate in either a startup mode or a sleep mode. The sleep mode is a mode in which no processing is performed other than processing for accepting a predetermined startup operation. The predetermined startup operation may be, for example, an operation of changing the writing pressure value to a value greater than 0 (i.e., an operation of causing the pen tip to come in contact with the panel surface 3a), or an operation of pressing the side switch 22. The startup mode is a mode entered when a predetermined startup operation is accepted, and the short-range wireless communication unit 28 that has entered the startup mode is in a state of being able to execute all functions including communicating with other devices via the short-range wireless communication BT, controlling the vibration device 21, and controlling to suppress the movement of the vibrator 21b during the pen non-use period.

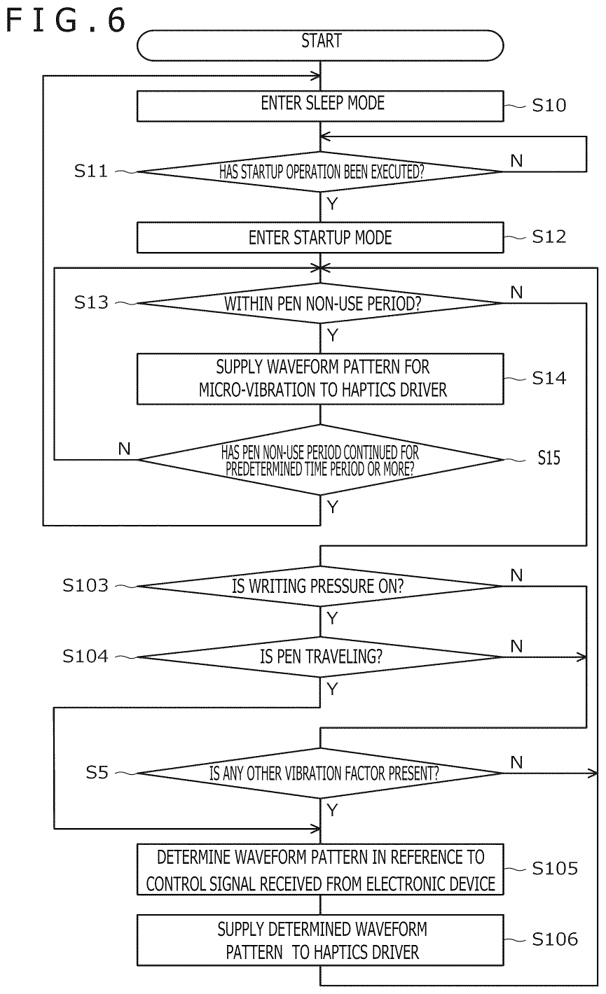

FIG. 6 is a process flow diagram illustrating the control of the vibration device 21 executed by the short-range wireless communication unit 28 according to the present embodiment. As illustrated in FIG. 6, the short-range wireless communication unit 28 first enters a sleep mode (step S10), and repeatedly executes a determination as to whether or not a predetermined startup operation has been executed, until a positive determination result is obtained (step S11).

In the case where a positive determination result is obtained in step S11, the short-range wireless communication unit 28 enters a startup mode (step S12) and determines whether or not the current time is within the pen non-use period (step S13). The details of this determination are similar to those in step S1 of FIG. 4.

The short-range wireless communication unit 28 that has determined in step S13 that the current time is not within the pen non-use period executes the processes in steps S103 to S106 and step S5, as in the example of FIG. 4. The details of the processing are similar to those in the case where it is determined in step S1 of FIG. 4 that the current time is not within the pen non-use period.

On the other hand, the short-range wireless communication unit 28 that has determined in step S13 that the current time is within the pen non-use period supplies a waveform pattern for micro-vibration to the haptics driver 29 (step S14). It is sufficient if the waveform pattern supplied here is the same as the waveform pattern supplied in step S4 of FIG. 4. As a result, an electric signal for vibrating the vibrator 21b with an amplitude so small that the user cannot recognize the vibration is supplied from the haptics driver 29 to the vibration device 21 (to both ends of the coil 21e), and consequently, the vibrator 21b cannot move freely, so that the vibration of the vibration device 21 caused by the impact generated when the pen tip is brought into contact with the panel surface 3a is suppressed.

Next, the short-range wireless communication unit 28 determines whether the pen non-use period has continued for a predetermined time period or more (step S15). The short-range wireless communication unit 28 that has obtained a positive determination result in this determination returns to step S10 and enters the sleep mode. On the other hand, the short-range wireless communication unit 28 that has obtained a negative determination result returns to step S13 and continues the processing.

As described above, according to the position detecting system 1 of the present embodiment, when the startup mode has been entered and the current time is within the pen non-use period, an electrical signal corresponding to a waveform pattern for micro-vibration is supplied to the vibration device 21, so that the movement of the vibrator 21b during the pen non-use period is suppressed. Hence, the vibration of the vibration device 21 caused by the impact generated when the pen tip is brought into contact with the panel surface 3a can be suppressed.

Note that, according to the position detecting system 1 of the present embodiment, when the user brings the pen tip into contact with the panel surface 3a while the short-range wireless communication unit 28 is in the sleep mode, the impact causes vibration of the vibration device 21. However, while the user is writing text or drawing a picture, even if the user removes the pen tip from the panel surface 3a, the short-range wireless communication unit 28 maintains the state of having entered the startup mode, as long as the removal is temporary, so that the position detecting system 1 of the present embodiment can sufficiently suppress vibration of the vibration device 21 that could be caused by the impact.

Next, the position detecting system 1 according to a third embodiment of the present disclosure will be described. The position detecting system 1 according to the present embodiment differs from the position detecting system 1 according to the first embodiment in the configuration and operation of the haptics driver 29 and the content of the control of the vibration device 21 executed by the short-range wireless communication unit 28, but is otherwise similar to the position detecting system 1 according to the first embodiment. The position detecting system 1 according to the present embodiment will be described below, by focusing on the differences from the position detecting system 1 according to the first embodiment.

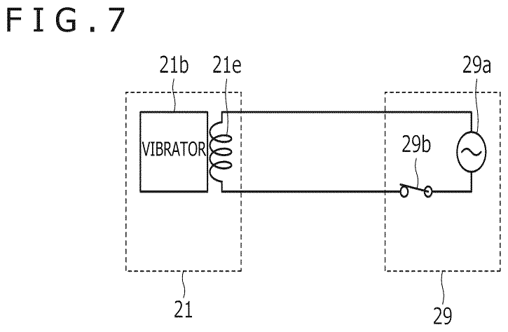

FIG. 7 is a diagram illustrating the functional blocks of the pen 2 according to the present embodiment. However, this diagram schematically illustrates only the parts related to the vibration device 21 and the haptics driver 29. As illustrated in FIG. 7, the haptics driver 29 includes an oscillator circuit 29a and a switch element 29b (drive switch) connected in series to the coil 21e in the vibration device 21.

The oscillator circuit 29a is a circuit that generates an electric signal that oscillates according to a waveform pattern supplied from the short-range wireless communication unit 28 illustrated in FIG. 3. The oscillator circuit 29a is configured to continuously generate an electric signal that oscillates according to the waveform pattern for micro-vibration described in the first embodiment, and, configured to, when a waveform pattern is supplied from the short-range wireless communication unit 28, switch the electric signal to be generated to an electric signal that oscillates according to the waveform pattern for a time period determined by the length of the waveform pattern. The switch element 29b is a single-pole single-throw switch that is inserted between the vibration device 21 (coil 21e) and the oscillator circuit 29a and serves to switch the connection state between the two. The electric signal generated by the oscillator circuit 29a is supplied to the coil 21e when the switch element 29b is on, whereas the electric signal is not supplied to the coil 21e when the switch element 29b is off.

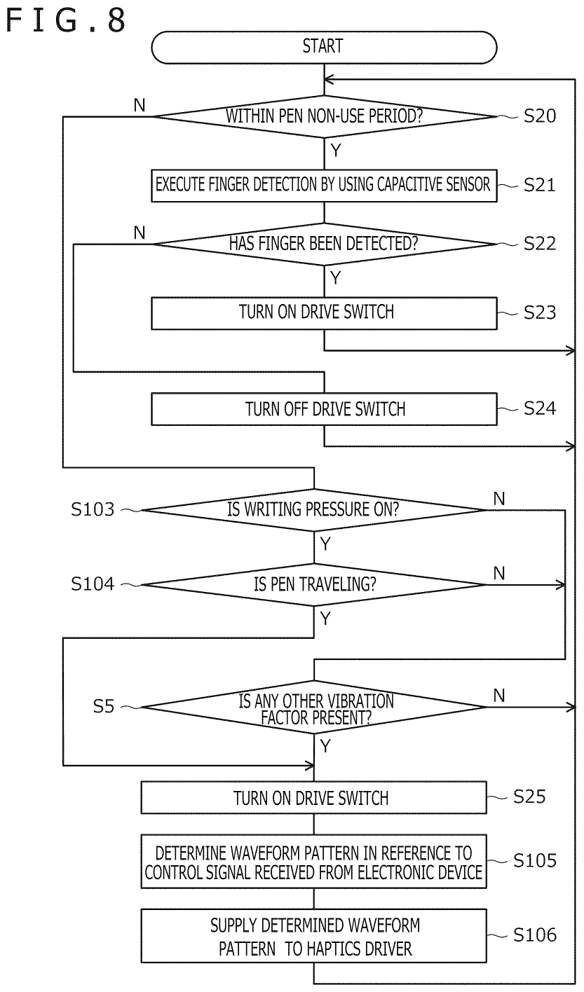

FIG. 8 is a process flow diagram illustrating the control of the vibration device 21 executed by the short-range wireless communication unit 28 according to the present embodiment. As illustrated in FIG. 8, the short-range wireless communication unit 28 first determines whether or not the current time is within the pen non-use period (step S20). The details of this determination are similar to those of step S1 in FIG. 4.

The short-range wireless communication unit 28 that has determined in step S20 that the current time is not within the pen non-use period executes steps S103 to S106 and step S5 as in the example of FIG. 4, but the short-range wireless communication unit 28 in the present embodiment executes a process of control to turn on the switch element 29b before executing step S105 (step S25). This is a measure to allow an electric signal (an electric signal generated by the oscillator circuit 29a) to flow through the coil 21e. When the switch element 29b is on at a stage prior to executing step S25, the short-range wireless communication unit 28 may skip step S25. This also applies to steps S23, S24, and S34 to be described later.

On the other hand, the short-range wireless communication unit 28 that has determined in step S20 that the current time is within the pen non-use period performs finger detection by using the capacitive sensor 27 (step S21), and determines whether a finger has been detected as a result (step S22). The short-range wireless communication unit 28 that has determined that a finger has not been detected turns off the switch element 29b (step S24), and then returns to step S20 to continue the processing.

On the other hand, the short-range wireless communication unit 28 that has determined in step S22 that a finger has been detected, turns on the switch element 29b (step S23), and then returns to step S20 to continue the processing. As a result, since an electric signal (an electric signal that is generated by the oscillator circuit 29a and oscillates according to a waveform pattern for micro-vibration) flows through the coil 21e, the vibration of the vibration device 21 is suppressed, as in the first embodiment.

As described above, according to the position detecting system 1 of the present embodiment, when the current time is within the pen non-use period and a finger is being detected by the capacitive sensor 27, an electric signal (an electric signal that is generated by the oscillator circuit 29a and oscillates according to a waveform pattern for micro-vibration) flows through the coil 21e, so that the movement of the vibrator 21b is suppressed during the pen non-use period. Hence, the vibration of the vibration device 21 caused by the impact generated when the pen tip is brought into contact with the panel surface 3a can be suppressed.

In addition, in the position detecting system 1 according to the present embodiment, as in the position detecting system 1 according to the second embodiment, the capacitive sensor 27 does not have to be provided in the pen 2 and steps S21 and S22 in FIG. 8 may be omitted, while still obtaining the same effects as described above.

In the position detecting system 1 according to the present embodiment, the generation of the electric signal by the oscillator circuit 29a itself may be turned on and off instead of the on/off control of the switch element 29b. In this way, in addition to the above described effects, the effect of reducing the power consumption of the pen 2 can also be obtained.

Next, the position detecting system 1 according to a fourth embodiment of the present disclosure will be described. The position detecting system 1 according to the present embodiment differs from the position detecting system 1 according to the third embodiment in that the pen 2 does not have the capacitive sensor 27, the short-range wireless communication unit 28 has a sleep mode, and that the content of the control of the vibration device 21 executed by the short-range wireless communication unit 28 is different. Otherwise, the present embodiment is similar to the position detecting system 1 according to the third embodiment. Below, the position detecting system 1 according to the present embodiment will be described, by focusing on the differences from the position detecting system 1 according to the third embodiment.

The functional blocks of the pen 2 and the electronic device 3 according to the present embodiment are similar to those according to the second embodiment illustrated in FIG. 5, except that the haptics driver 29 has the configuration illustrated in FIG. 7. The short-range wireless communication unit 28 according to the present embodiment is configured to operate in either the startup mode or the sleep mode, similarly to the short-range wireless communication unit 28 according to the second embodiment. Details of each mode are as described in the second embodiment. However, in the sleep mode according to the present embodiment, the switch element 29b in the haptics driver 29 is turned off.

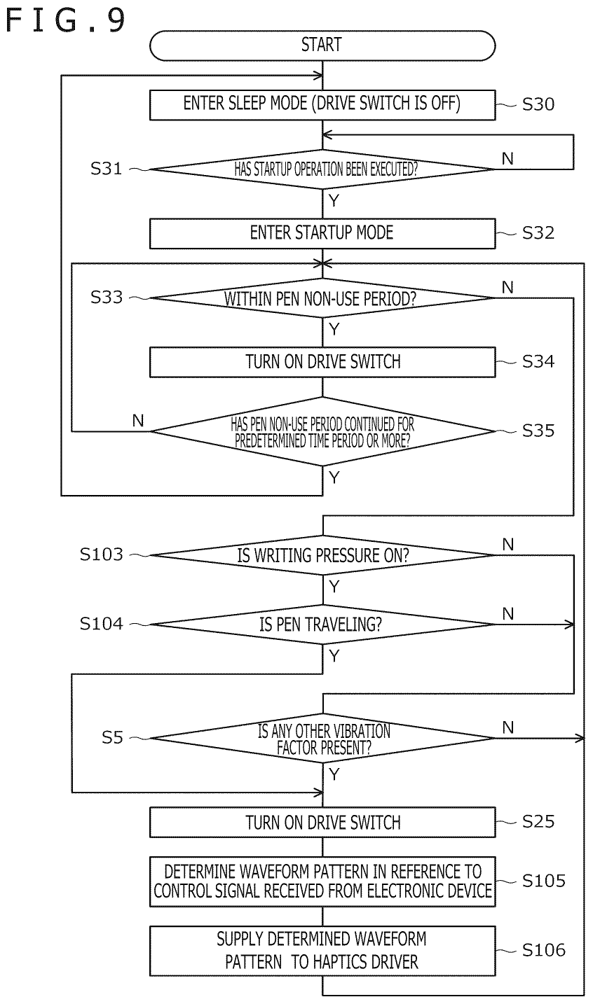

FIG. 9 is a process flow diagram illustrating the control of the vibration device 21 executed by the short-range wireless communication unit 28 according to the present embodiment. As illustrated in FIG. 9, the short-range wireless communication unit 28 according to the present embodiment first enters a sleep mode (step S30), and repeatedly executes a determination as to whether or not a predetermined startup operation has been executed, until a positive determination result is obtained (step S31). At this time, the switch element 29b is off.

In the case where a positive determination result is obtained in step S31, the short-range wireless communication unit 28 enters a startup mode (step S32) and determines whether or not the current time is within the pen non-use period (step S33). The details of this determination are similar to those in step S1 of FIG. 4.

The short-range wireless communication unit 28 that has determined in step S33 that the current time is not within the pen non-use period executes the processes of steps S103 to S106, step S5, and step S25 as in the example of FIG. 8. The details of this point are as described with reference to FIGS. 4 and 8.

On the other hand, the short-range wireless communication unit 28 that has determined in step S33 that the current time is within the pen non-use period performs control to turn on the switch element 29b (step S34). As a result, an electric signal (an electric signal that is generated by the oscillator circuit 29a and oscillates according to a waveform pattern for micro-vibration) flows through the coil 21e, so that the vibration of the vibration device 21 is suppressed as described above. Thereafter, the short-range wireless communication unit 28 determines whether the pen non-use period has continued for a predetermined time period or more (step S35). When a positive determination result is obtained, the short-range wireless communication unit 28 returns to step S30 and enters the sleep mode. At this time, the switch element 29b returns to off. On the other hand, the short-range wireless communication unit 28 that has obtained a negative determination result returns to step S33 and continues the processing.

As described above, according to the position detecting system 1 of the present embodiment, when the startup mode has been entered and the current time is within the pen non-use period, an electric signal (an electric signal that is generated by the oscillator circuit 29a and oscillates according to a waveform pattern for micro-vibration) flows through the coil 21e, and the movement of the vibrator 21b is suppressed during the pen non-use period. Therefore, the vibration of the vibration device 21 caused by the impact generated when the pen tip is brought into contact with the panel surface 3a can be suppressed.

It should be noted that, according to the position detecting system 1 of the present embodiment, when the user brings the pen tip into contact with the panel surface 3a while the short-range wireless communication unit 28 is in the sleep mode, the impact causes vibration of the vibration device 21 as in the position detecting system 1 of the second embodiment. However, even if the user removes (separates) the pen tip from the panel surface 3a while writing text or drawing a picture, since the short-range wireless communication unit 28 maintains the state of having entered the startup mode as long as the detachment is temporary, the position detecting system 1 of the present embodiment can sufficiently suppress vibration of the vibration device 21 that could be caused by the impact.

Although the embodiments of the present disclosure have been described above, the present disclosure is not limited to these embodiments, and can be embodied in various further embodiments based on the present disclosure.

For example, in each of the above embodiments, an example is described in which the short-range wireless communication BT is used to transmit identification information that identifies a waveform pattern from the electronic device 3 to the pen 2. However, the identification information may be transmitted using uplink signal US, for example.

What is claimed is:

1. A pen, comprising:
a vibration device including a vibrator; and
a processing unit that suppresses movement of the vibrator during a pen non-use period during which no pen input is being performed.

2. The pen according to claim 1, wherein the processing unit is configured to:
supply a first electrical signal to the vibration device to vibrate the vibration device while a user is writing with the pen, and
suppress the movement of the vibrator during the pen non-use period, by supplying during the pen non-use period a second electrical signal to the vibration device, the second electrical signal oscillating with an amplitude smaller than that of the first electrical signal.

3. The pen according to claim 2, wherein
the vibration device includes a coil, and
the processing unit supplies the second electrical signal to the vibration device by supplying the second electrical signal to both ends of the coil.

4. The pen according to claim 1, comprising:
an oscillator circuit; and
a switch element inserted between the vibration device and the oscillator circuit,
wherein
the vibration device includes a coil, and
the processing unit turns on the switch element during the pen non-use period to allow an electrical signal to flow through the coil to thereby suppress the movement of the vibrator during the pen non-use period.

5. The pen according to claim 4, wherein
the electrical signal is generated by the oscillator circuit.

6. The pen according to claim 1, comprising:
a capacitive sensor arranged on a surface of the pen,
wherein
the processing unit suppresses the movement of the vibrator when a current time is within the pen non-use period and a finger is being detected by the capacitive sensor.

7. The pen according to claim 1, wherein the processing unit is configured to:
enter a startup mode in response to a predetermined startup operation, and to enter a sleep mode when a state in which no pen input is performed continues for a predetermined time period or more after entering the startup mode, and
suppress the movement of the vibrator when the processing unit has entered the startup mode and a current time is within the pen non-use period.
